(19) United States
(12) Patent Application Publication
(10) Pub. No.: US 2022/0374914 A1
(43) Pub. Date: Nov. 24, 2022

(54) REGULATORY OBLIGATION IDENTIFIER

(71) Applicant: PricewaterhouseCoopers LLP, New York, NY (US)

(72) Inventors: Todd MORRILL, Newburgh, NY (US); Eric ROMA, Brooklyn, NY (US); Neelam SHARMA, Manalapan, NJ (US); Alistair MOORE, Chicago, IL (US); Andrew RUNGE, Pittsburgh, PA (US)

(73) Assignee: PricewaterhouseCoopers LLP, New York, NY (US)

(21) Appl. No.: 17/722,075

(22) Filed: Apr. 15, 2022

Related U.S. Application Data
(60) Provisional application No. 63/190,713, filed on May 19, 2021.

(51) Int. Cl. G06Q 30/00; G06N 20/00

(52) U.S. Cl. CPC G06Q 30/018; G06N 20/00

(57) ABSTRACT

Described herein is a machine-learning model that categorizes and classifies regulatory text and methods for operation thereof. The machine-learning model may receive raw data. The raw data may be data in a file that includes a list of text examples (e.g., leaf node citation texts). One or more datasets may be annotated. A training, validation, and test dataset may be generated. The machine-learning model is used to determine one or more predictions regarding the category and classification of input data. The training dataset is used to train the machine-learning model, the validation dataset is used to tune the hyper parameters of the model, and the test dataset is used to evaluate its performance. The prediction(s) are stored or sent to one or more downstream applications.

### CROSS-REFERENCE TO RELATED APPLICATION

This application claims the benefit of U.S. Provisional Application No. 63/190,713, filed May 19, 2021, the contents of which are incorporated herein by reference in its entirety for all purposes.

### FIELD

This disclosure relates generally to a machine-learning model that categorizes and classifies regulatory text.

### BACKGROUND

Organizations have to comply with regulations. The process for determining which regulations an organization must comply with and what is required in order to meet compliance may involve a regulatory compliance team reviewing the entirety of hundreds or thousands of regulatory documents. Given the large number of regulations, this process may be expensive, manually intensive, time consuming, and prone to errors and subjective opinions. The regulations are set forth by different regulators, which may have different standards, formats, terminology, etc. There may be a large number of regulations and regulatory documents; the regulatory documents may be long and may include complex regulatory text. These factors may further add to the burden, complexity, and time needed for an organization to determine which regulations an organization must comply with and whether the organization is in compliance. Regulations get updated frequently, so this tedious process may have to be repeated every time a regulation (regulatory requirement) is updated.

Auditors are used to determine whether an organization is complying with regulations. Auditors may need a complete inventory of all regulations, laws, and regulatory documents. The large inventory may make it difficult for the auditors to complete an audit in a time efficient manner and without missing any regulations.

What is needed is an automated regulatory obligation identifier (ROI) that categorizes and classifies segments of regulatory text. The ROI may standardize the decision making and make consistent decisions. The ROI may be more thorough, capable of identifying all potential obligations. Additionally or alternatively, the ROI processes segments of regulatory text, leading to faster decisions due to its ability to process thousands of segments of text in, e.g., seconds (compared to hours). The categorization may allow an organization to prioritize certain regulations and focus on the segments of regulatory text most applicable to a given organization.

What is needed is an automated regulatory obligation identifier that groups the categories into different classifications. The classifications may be a simple way to indicate whether or not the organization is obligated to comply with a given regulatory requirement. What is also needed is a way for auditors to validate the completeness of a regulatory inventory.

### BRIEF SUMMARY

A method for determining one or more predictions for meeting one or more regulatory requirements is disclosed. The method may comprise: receiving regulatory text of one or more regulatory documents; receiving information about an organization; and using a machine-learning model to: apply the regulatory text against the information about the organization; and generate the one or more predictions, wherein the one or more predictions include one or more categories and a classification, wherein the one or more categories include regulator action, exception/exemption, definition, background, example, regulatory requirement, conditionally permitted, calculations, and prohibition, wherein the classification is an indicator of whether the organization is obligated to comply with the one or more regulatory requirements. In some embodiments, the method may comprise: outputting the one or predictions, wherein the output comprises a probability for each of the one or more categories. In some embodiments, the method may comprise: outputting one of the one or more categories having a highest probability. In some embodiments, the classification is a binary indicator. In some embodiments, the method may comprise: training the machine-learning model using a training dataset; testing the trained machine-learning model using a test dataset; determining whether the trained machine-learning model meets a target performance; and when the trained machine-learning model does not meet the target performance: changing the training dataset; and repeating the training and testing using the changed training dataset. In some embodiments, wherein training the machine-learning model comprises: determining one or more relationships between annotations and data in an annotated dataset. In some embodiments, wherein the one or more relationships are determined by associating words in segments of the regulatory text to the annotations. In some embodiments, the annotations include a citation identifier, a website link, a regulator, a data source, a name of one of the one or more regulatory documents, a topic, a corresponding category, a corresponding classification, or machine-learning information. In some embodiments, the test dataset comprises text from multiple regulations and multiple topics. In some embodiments, changing the training dataset includes adding additional data to the training dataset. In some embodiments, the additional data includes data belonging to the same category as data in the training dataset from an incorrect prediction. In some embodiments, changing the training dataset includes modifying existing data of the training dataset. In some embodiments, modifying the existing data includes modifying data in the training dataset from an incorrect prediction. In some embodiments, training the machine-learning model comprises: generating pre-trained embeddings; batching a training dataset into a configurable batch set, wherein the training dataset is included in the training dataset; using the pre-trained embeddings to look up word embeddings on input text of the training dataset; forming a convolution neural network; and performing iterative optimizations. In some embodiments, generating the pre-trained embeddings comprises: tokenizing the input text; designating the words as vocabulary words; generating a vector using the vocabulary words; and providing the vector to the convolution neural network. In some embodiments, the vocabulary words are regulation-based words. In some embodiments, the annotated dataset includes a training dataset, a validation dataset, and a test dataset, wherein training the machine-learning model comprises: tuning the model's parameters using the training dataset, tuning the hyper parameters using the validation dataset; and terminating the training of the machine-learning model based on one or more monitored metrics. In some embodiments, the development of the machine-learning model involves using different configurations and comparing the different configurations to determine a configuration with a highest performance, wherein the training of the machine-learning model includes using the configuration with the highest performance. In some embodiments, generating the one or more predictions includes determining one or more probabilities using a softmax layer of a convolution neural network used by the machine-learning model.

A non-transitory computer readable medium is disclosed. The computer readable medium may comprise instructions that, when executed, perform a method for determining one or more predictions for meeting one or more regulatory requirements, the method comprising: receiving regulatory text of one or more regulatory documents; receiving information about an organization; and using a machine-learning model to: apply the regulatory text against the information about the organization; and generate the one or more predictions, wherein the one or more predictions include one or more categories and a classification, wherein the one or more categories include regulator action, exception/exemption, definition, background, example, regulatory requirement, conditionally permitted, calculations, and prohibition, wherein the classification is an indicator of whether the organization is obligated to comply with the one or more regulatory requirements.

### BRIEF DESCRIPTION OF THE FIGURES

FIG. 1 illustrates a flow chart of an exemplary operation of the regulatory obligation identifier, according to embodiments of the disclosure.

FIG. 2 illustrates a flow chart of an exemplary process for training a machine-learning model, according to embodiments of the disclosure.

FIG. 3 illustrates a block diagram of an exemplary system, according to embodiments of the disclosure.

### DETAILED DESCRIPTION

Described herein is a machine-learning model that categorizes and classifies regulatory text and methods for operation thereof. The machine-learning model may receive raw data. The raw data may be data in a file that includes a list of text examples (e.g., leaf node citation texts). One or more datasets may be annotated. A training, validation, and test dataset may be generated. The machine-learning model is used to determine one or more predictions regarding the category and classification of input data. The training dataset is used to train the machine-learning model, the validation dataset is used to tune the hyper parameters of the machine-learning model, and the test dataset is used to evaluate its performance. The prediction(s) are stored or sent to one or more downstream applications. In some embodiments, the training dataset may be used to tune the parameters of the machine-learning model.

The following description is presented to enable a person of ordinary skill in the art to make and use various embodiments. Descriptions of specific devices, techniques, and applications are provided only as examples. These examples are being provided solely to add context and aid in the understanding of the described examples. It will thus be apparent to a person of ordinary skill in the art that the described examples may be practiced without some or all of the specific details. Other applications are possible, such that the following examples should not be taken as limiting. Various modifications in the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various techniques and process flow steps will be described in detail with reference to examples as illustrated in the accompanying drawings. In the following description, numerous specific details are set forth in order to provide a thorough understanding of one or more aspects and/or features described or referenced herein. It will be apparent, however, to a person of ordinary skill in the art, that one or more aspects and/or features described or referenced herein may be practiced without some or all of these specific details. In other instances, well-known process steps and/or structures have not been described in detail in order to not obscure some of the aspects and/or features described or referenced herein.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combination of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Overview of an Exemplary Regulatory Obligation Identifier

As discussed in more detail below, the disclosed regulatory obligation identifier receives input data and produces output data, comprising one or more predictions. In some embodiments, the input data may be raw data. The raw data may be data in a file that includes a list of text examples (e.g., leaf node citation texts).

In some embodiments, the input data may also include regulatory text. A machine-learning model is trained, tested, and then used to make predictions regarding the category and classification of the input data. The category and classification information may be sent to one or more downstream applications for downstream consumption.

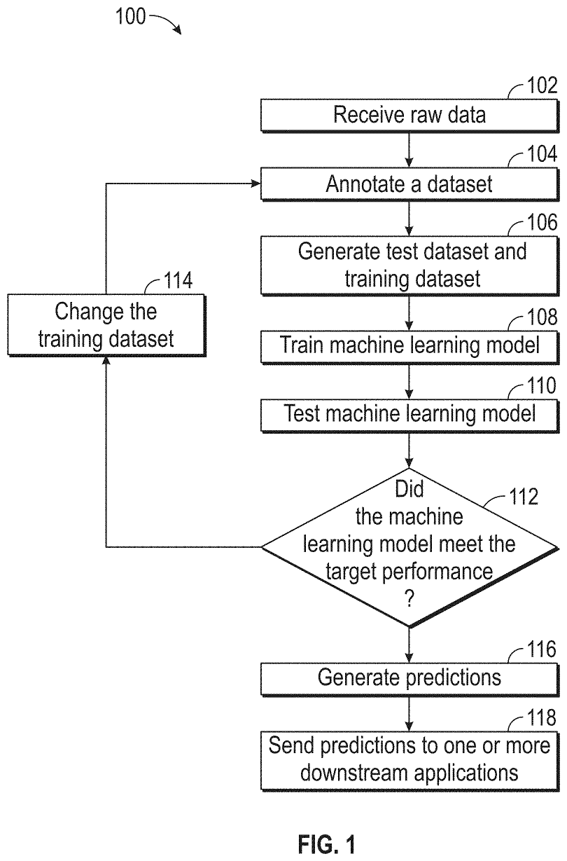

FIG. 1 illustrates a flow chart of an exemplary operation 100 of a regulatory obligation identifier, according to embodiments of the disclosure. In step 102, a dataset is received. The dataset may include regulatory text. In some embodiments, the regulatory text may be organized into a hierarchical structure. In some embodiments, the dataset may be raw data. The raw data may represent one or more regulations and/or laws. The raw data may be a string of text or a CSV file, for example, with a “Text” column composed of one or more strings of text.

In step 104, a dataset is annotated. The annotating step may include annotating the data (e.g., regulatory text) in the regulatory database with one or more labels. In some embodiments, the annotating step may involve annotating segments of the regulation(s), regulatory document(s), and/or one or more laws or a subset of laws with information such as the citation identifier, website link for the regulatory document, the regulator, the data source, the name of the document, the topic, one or more corresponding categories, the corresponding classification, machine-learning information (e.g., which machine-learning set it is assigned to), whether there is a label, etc. In some embodiments, the annotating step may involve determining whether the regulation(s), regulatory document(s), and/or law(s) are in-scope, which occurs when collectively making a complete representation for all regulators, data sources, and topics. Step 104 is discussed in more detail below.

In step 106, training, validation, and test datasets are generated. The training dataset is used to train the machine-learning model. The validation dataset is used for tuning the machine-learning model's hyper parameters. The test dataset is used to evaluate the performance of a machine-learning model. Python may be used to create the machine-learning model. Certain libraries, such as gensim, torchtext, and PyTorch, may be used to test and develop the machine-learning model. Embodiments of the disclosure may include, but are not limited to, using Skorch for the pipeline (e.g., hyper parameter tuning) and pandas for data handling. Step 106 is discussed in more detail below.

In step 108, the machine-learning model is trained. The training and validation datasets may include collections of data points comprising regulatory text and annotations. Step 108 is discussed in more detail below.

In step 110, the machine-learning model is tested. The machine-learning model may be tested with the test dataset, for example. In some embodiments, the test dataset may include text from multiple regulators, various regulations and may cover multiple, various topics. The machine-learning model's performance is compared to a target performance in step 112. The comparison may check to whether the categorization and classifications determined by the machine-learning model are the same as the test dataset. In some embodiments, the comparison may involve determining the precision and recall of the positive (obligation) class. A threshold percentage (e.g., 90% correct) may be used to determining whether the machine-learning model meets the target performance. If the machine-learning model's performance does not meet a target performance, then the training dataset is changed (step 114). Changing the training dataset may include adding additional data to the training dataset or modifying existing data in the training dataset. The additional data may include regulatory text and annotations, for example. In some embodiments, the existing data may be modified if the regulatory text itself or its categorization has changed. Steps 104-110 are then repeated. In some embodiments, the additional data may include data representative of the areas where the machine-learning model underperformed. For example, if the machine-learning model makes an incorrect prediction for a given category, data belonging to that same category is added to the training dataset. In some embodiments, an incorrect prediction occurs when the categorization having the highest probability is incorrect. In some embodiments, the data in the training dataset is modified, where the modified data involves the incorrect prediction.

In step 116, the machine-learning model receives a regulation or segment(s) of regulatory text and applies it against the information about the organization. The regulation applied against the information about the organization may be only those regulations relevant to the organization. The machine-learning model may generate one or more predictions for a regulation. In some embodiments, the machine-learning model may generate one or more predictions for a given batch. A batch may include multiple (e.g., 64) segments of regulatory text. The machine-learning model may iterate through multiple batches. Step 116 is discussed in more detail below.

In step 118, the predictions made by the machine-learning model are sent to one or more downstream applications for downstream consumption or stored for retrieval by the downstream application(s). The predictions may be stored in a, e.g., CSV file, presented on the screen to a user, consumed by downstream applications, or persisted in memory for later use.

### Exemplary Data Annotating

Data annotation involves annotating (e.g., labeling) a dataset. The dataset can include one or more regulations, one or more regulatory documents, or a combination thereof. The annotated dataset may be used to train a machine-learning model how to make predictions by having it determine one or more relationships between the regulatory text and the annotated data in the dataset.

Embodiments of the disclosure include annotating a regulatory document (e.g., a Code of Federal Regulations (CFR) regulation, U.S. Code (USC) law, Office of the Comptroller of the Currency (OCC) Bulletin, Federal Reserve Board (FRB) Supervision and Regulation (SR) Letter, etc.). A file (e.g., an excel spreadsheet) is created with a plurality of rows. Each row can include information in a plurality of columns. The information may include, but is not limited to, the text of a regulatory citation, the citation identification, a website link to the regulatory document, the source of the regulatory document, the name of the regulatory document being annotated, the regulator, the topic, and the category. The topic may indicate the topic of the law/regulation, such as consumer, markets, or the like.

In some embodiments, one or more annotations for a segment of regulatory text may be stored in a separate file. The file(s) for annotated text may be stored in a datastore.

In some embodiments, the text of a regulatory citation may include the entire text of all parts (e.g., segments, levels, etc.) and subparts (e.g., portions of a segment, sublevels, etc.) of a regulation.

In some embodiments, the category may be a multi-class category, each category may have an associated classification. Exemplary categories include, but are not limited to, the ones shown in Table 1. In some embodiments, a classification can be a binary (e.g., yes or no, true or false, etc.) indication whether or not an organization is obligated to comply with a regulation. Although Table 1 lists nine categories, embodiments of the disclosure may include fewer categories, more categories, and/or different categories.

TABLE 1
Exemplary categories for regulatory text

| Category | Description | Classification |
|---|---|---|
| Regulator | Allows for the regulator to take action to | No |
| Action | ensure compliance with the regulation; | |
| | Requires an action by the regulator; OR | |
| | Section reserved by the regulator for potential | |
| | future requirement | |
| Exception/Exemption | Provides a carve-out of certain elements of the rule | No |
| | (e.g., things not covered by the regulation) | |
| Definition | Defines key terms in the rule | No |
| Background | Sets the parameters of the rule (e.g., duration, | No |
| | organization activities covered, etc.) | |
| | Provides context or section headers (short | |
| | segments of text) | |
| Example | Provides an example of how an organization can | No |
| | comply with a requirement | |
| Regulatory | Requirements that the organization must comply | Yes |
| Requirement | with | |
| Conditionally | Identifies permissible activities, if the organization | Yes |
| Permitted | takes certain actions | |
| Calculations | Establishes the methodology for relevant | Yes |
| | calculations | |
| Prohibition | Identifies impermissible activities that the | Yes |
| | organization cannot perform | |

In some embodiments, the annotated data may be reviewed and/or updated. The annotated data may be reviewed/updated by different annotators. In some embodiments, for a given citation identification, information such as supporting metadata may be stored. The supporting metadata may include one or more (e.g., all) of the fields discussed above. The information may be stored in a file.

### Exemplary Training, Validation, and Test Datasets

A training dataset is used to train a machine-learning model to make predictions. The training dataset is used for training the machine-learning model how to use the input data and make a prediction. The validation dataset is used for tuning the machine-learning model's hyper parameters. In some embodiments, the validation dataset may be used to run multiple experiments to determine which configuration of the model performs the best. In some embodiments, these experiments include using a grid search to determine which of the hyper parameters the model uses.

Embodiments of the disclosure may include using different configurations to develop the machine-learning model. The developed machine-learning model may be evaluated using the validation set. The configuration with the highest performance (compared to performances of the other configurations) is then used. The validation dataset is also used for controlling when training of the machine-learning model should be terminated. That is, the training of the machine-learning model is terminated based on one or more monitored metrics. In some embodiments, the termination prevents overfitting. For example, if the validation loss does not decrease for a number (e.g., three) of epochs, the training may be terminated.

A test dataset is data used to test the performance of a machine-learning model. In some embodiments, the test dataset is annotated. The annotated dataset may be split into several portions. A first portion may be set aside as the test dataset. The remaining dataset may be further subdivided into a second portion and a third portion corresponding to the training and validation datasets, respectively. The second portion (e.g., 80% of the remaining dataset) of the annotated dataset may be the training dataset, and the third portion (e.g., 20% of the remaining dataset) of the annotated dataset may be the validation dataset.

### Exemplary Training of a Machine-Learning Model

The machine-learning model may receive an annotated dataset. The annotated dataset may comprise segments of regulatory text and a corresponding annotation. The machine-learning model may use the annotations to learn relationships by associating words in the segment of regulatory text to one or more annotations. The relationships may be between the annotations and data. For example, the machine-learning model can determine that data having a certain property is assigned to a given category. The machine-learning model may compare its predicted output to an expected output. In some embodiments, the machine-learning model may use the comparison information to refine its predictions.

Using the relationships, the machine-learning model may then annotate the input data with its predictions. The machine-learning model may use these annotations to form one or more predictions regarding the category that the input data belongs to and the classification for the category.

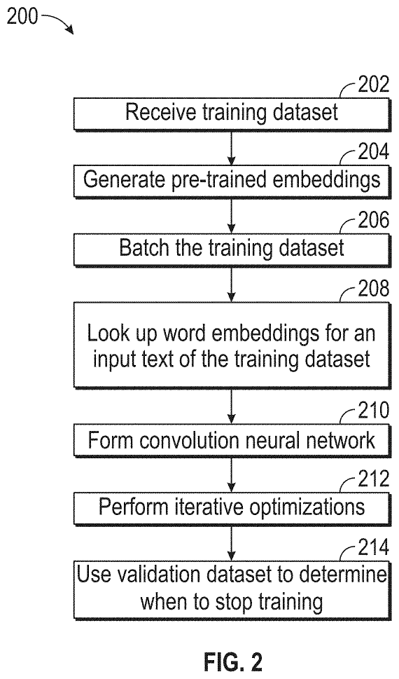

FIG. 2 illustrates a flow chart of an exemplary process 200 for training a machine-learning model, according to embodiments of the disclosure. In step 202, the machine-learning model may receive a training dataset.

Step 204 involves generating pre-trained embeddings by learning word embeddings and word classifications using the training dataset. In some embodiments, the pre-trained embeddings may be generated using an open-source algorithm, such as FastText, to one or more segments of regulatory text. Word embeddings may be numerical representations of words based on the words frequently appearing next to it. Regulatory text from regulatory documents are first preprocessed by tokenizing strings into individual words. The tokenizer may split the regulatory text based on delimiters, such as spaces and punctuation marks (e.g., commas, periods, etc.). The words may be looked up in a dictionary of existing words and converted to an integer identifier. The dictionary of existing words may include all words present in a training corpus, for example. The integer identifiers may be used to look up word embeddings.

One or more (e.g., all) words in the text from one or more regulatory documents may be designated as vocabulary words, and words later encountered during validation, evaluation, or at interference time may be included as part of the out-of-vocabulary (OOV) words. In some embodiments, words that appear a certain number (e.g., at least two) across all of the regulatory documents are designed as vocabulary words. The vocabulary words may include regulation-based words. In some embodiments, rare words that appear in a text example that are not found in the dictionary are replaced by a special OOV vector.

An embedding algorithm may generate word embeddings using vocabulary words. Word embeddings are multidimensional vectors. The vector may represent the meaning of a word in the context of other vocabulary words. In some embodiments, the word embeddings may be generated using an open-source algorithm, such as FastText, word2vec, GloVe, one-hot encoding, TF-IDF, or word embeddings generated while training a deep learning model. The embedding algorithm model may be Skipgram, continuous bag of words (CBOW), etc., as non-limiting examples. The word embeddings model may produce a high-dimensional vector representation of the words. For example, the vector may be a 300 dimensional vector for each word, where the word embeddings model may be trained with 10 negative samples per positive example for 10 epochs (iterations) and a context window size of five. There may be requirements imposed on the word embeddings model, such as the requirement that a word appear two or more times in a corpus.

In step 206, the training dataset may be batched into a configurable batch size. In some embodiments, the training may include shuffling the data between epochs to minimize training loss and to help the training converge faster. In some embodiments, the data may be shuffled using random number generators. The algorithm minimizes the training loss (as described above), where the machine-learning model's predictions are compared to one or more annotations, and such comparison is used to tune the machine-learning model. Additionally or alternatively, cross entropy may be used to minimize the loss between the predictions made by the machine-learning model and the target categories.

In step 208, the integer identifiers corresponding to words are used to look up the word embeddings for an input text from the training dataset. In step 210, a convolution neural network (CNN) is formed. Convolution filter shapes may correspond to short sequences of text (e.g., 3 or 4 words) and local patterns may be identified. This may serve the purpose of extracting out the most salient features of each input text. The max pooled output from each of the convolution layers may be concatenated and then a resulting vector may be formed. The resulting vector may represent the extracted features for a given input text. The network may include a fully connected layer and a softmax layer, which are applied to the aforementioned feature vector. The softmax layer may be used to determine the probability of the input data (e.g., regulatory text) having a given category. The CNN may also include one or more dropout layers. The dropout layers may help the machine-learning model generalize to new unseen data. A dropout layer may prevent information from flowing from one layer to the next and may ensure the machine-learning model relies on all the information available to it.

The training may utilize tunable hyper parameters. In some embodiments, a configuration file (e.g., a YAML-formatted configuration file) may be used to specify a complete assignment to the model's hyper parameters. Grid search may be used to find the optimal configuration of hyper parameters that maximizes a validation set performance metric. Exemplary hyper parameters include, but are not limited to, the number of convolution filters, filter sizes, batch sizes, and dropout rate.

The configuration file may include embeddings settings, vocabulary settings, CNN settings, or the like. For example, the CNN may have three convolution layers with a configurable filter size and a stride of one over the input text, followed by a max pool over the input text for each of the convolution filters. Table 2 below shows the contents of an exemplary configuration file.

TABLE 2
Exemplary contents of a configuration file
Embedding Settings

| | | |
|---|---|---|
| train_dirs | directories where csv or tsv files can be found with a | N/A |
| | ‘Text’ column | |
| embeds_dir | directory where embedding artifacts will be saved | N/A |
| sg | 1 for Skipgram, 0 for CBOW | 1 |
| embed_size | embedding dimensions | 300 |
| min_count | minimum word frequency to be included in the | 2 |
| | vocabulary words | |
| vocab_size | maximum size of the vocabulary words | 50000 |
| seed | random seed for reproducibility | 42 |
| negative | number of negative samples | 10 |
| epochs | number of passes through the dataset | 10 |
| deterministic | If set to True, models will be reproducible. Only runs on | False |
| | 1 thread. Will take longer. | |
| lowercase | lowercase words passing through tokenizer, if True, be | False |
| | sure to update tokenizer elsewhere (e.g., train.py) | |

Vocabulary Settings

| | | |
|---|---|---|
| word_freq_file_path | word frequency file from FastText training | N/A |
| vectors_file_path | word embeddings from FastText training | N/A |
| vocab_dir | directory where embedding artifacts will be saved | N/A |

CNN Settings

| | | |
|---|---|---|
| run_dir | directory where experiment results will be stored | N/A |
| data_dir | path containing the train, validation, and test files | N/A |
| vocab | path to pickled vocabulary object | N/A |
| word_vectors | path to pre-trained word embeddings | N/A |
| embed_size | see above | 300 |
| n_filters | number of convolutional layer filters | 100 |
| filter_sizes | length of the filters (i.e., number of words) | [2, 3, 4] |
| max_epoch | maximum number of training epochs (will be limited by | 50 |
| | patience) | |
| patience | stop training when the model fails to improve for this | 3 |
| | many epochs | |
| lr | learning rate - Adam is the optimizer | 0.001 |
| batch_size | number of instances per batch during training | 32 |
| dropout | dropout applied just before the fully connected layer | 0.2 |
| train_mode | can perform a single training run, a grid search over the | skorch |
| | parameters, or manual training job with ‘skorch,’ ‘grid,’ | |
| | ‘manual,’ respectively | |
| n_iter | limit the number of grid search runs by randomly | 12 |
| | selecting n configurations, used in conjunction with | |
| | train_mode: grid | |

In step 212, an optimization algorithm is used to perform iterative optimizations. This step may include optimizing a loss metric. The loss metric may indicate how different the machine-learning model's predictions are to the expected output. As non-limiting examples, the Adam optimization algorithm or RMSProp with default settings may be used.

In step 214, a validation dataset is used to determine when to stop training. The stopping point may be determined based on validation loss. For example, when the performance (e.g., validation loss, validation set recall, accuracy score, etc.) does not improve a certain period (e.g., three epochs), training may be terminated.

### Exemplary Testing of a Machine-learning Model

The machine-learning model may be tested to determine whether or not its predictions meet a target performance. The machine-learning model's output may be compared to a test dataset. An exemplary incorrect prediction is shown in Table 3 below. Although the below table includes an explanation, the explanation may not be given to the machine-learning model. In some embodiments, the explanation may be used by a user to determine information such as which word embeddings and/or data (additional or existing) should be added to or modified in the training dataset, which annotations should be modified, etc.

TABLE 3
Exemplary incorrect prediction

| | |
|---|---|
| Citation identification | LET: SR9403: 5: 1 |
| Regulatory text | “The requirements of Section 36 will have an impact on the basic |
| | training needs of Reserve System personnel. Foremost is the need to |
| | educate personnel in the requirements of Section 36, including |
| | attendant policies and procedures developed to satisfy these |
| | requirements. Furthermore, examiners and other personnel that will |
| | be reviewing CPA workpapers and reports will need to develop or |
| | further refine their knowledge and expertise in the following |
| | areas: (i) GAAP, GAAS, and Attestation Standards, (ii) CPA |
| | workpaper techniques and related review procedures, and (iii) CPA |
| | firm quality review program. Federal Reserve System training |
| | programs to address these matters are under development.” |
| Correct Category | Regulator action |
| Predicted category | Regulatory requirement |
| Explanation | The key phrase here is “training needs of Reserve System |
| | personnel,” where Reserve System refers to the Federal Reserve, |
| | which is a regulator. This implies that the regulator has an action to |
| | take regarding training programs. |

If the machine-learning model's predictions are incorrect for data (e.g., regulatory text) in a given category, additional data for the given category may be added to the training dataset, or the data involving the inaccurate prediction(s) may be modified, and the machine-learning model may then be trained and tested again. For example, as shown in the table above, the machine-learning model incorrectly predicted the example text should be categorized as “Regulatory requirement.” The correct prediction is “Regulator action.” The explanation may be used to determine that the training dataset should include an input text for the key phrase “training needs of Reserve System personnel,” annotated with the “Regulatory action” category.

In some embodiments, when the machine-learning model is underperforming on regulations from a particular regulator, more annotated regulations from the same regulator are added to the training dataset. In some embodiments, this additional data is appended to the existing training dataset, and the model is trained again.

### Exemplary Predictions Made by a Machine-learning Model

As discussed above, after training and testing, the machine-learning model receives regulatory text as input data and makes predictions. The predictions include the probability of the input data having a given category and a given binary classification. In some embodiments, the predictions that are provided may include a probability for each category.

Table 4 below shows the machine-learning model's output including exemplary predictions. As shown below, the machine-learning model may also output the category having the highest probability. In some embodiments, the machine-learning model may process multiple segments of text in parallel.

TABLE 4
Exemplary output of predictions made by a machine-learning model

| | |
|---|---|
| Regulatory Text Data | “As of Nov. 20, 2013, this guidance applies to |
| | federal savings associations in addition to national |
| | banks.” |
| Citation identification | BUL: 2005-9: 1 |
| Website link | https://www.occ.treas.gov/news-issuances/bulletins/2005/bulletin-2005-9.html |
| Source of the regulatory document | Contractor |
| Name of the regulatory document | Overdraft Protection Programs: Interagency Guidance |
| Regulator | OCC |
| Population | 31 Dec. 20 |
| Predicted category | Background |
| Predicted classification | FALSE |
| Unknown probability | 7.65E−06 |
| Regulator action probability | 0.00153997 |
| Exception/Exemption probability | 0.00012237 |
| Definition probability | 0.00109199 |
| Background probability | 0.9953849 |
| Examples probability | 0.00013694 |
| Regulatory requirement probability | 0.0014158 |
| Conditionally permitted probability | 0.00011416 |
| Calculations probability | 0.00011474 |
| Prohibition probability | 7.15E −05 |

In some embodiments, the ROI may output the categorization of a snippet of regulatory text. The ROI provides a probability score associated with its prediction that can be used as a confidence score. Lower confidence scores could be manually inspected to ensure accuracy. The ROI output may allow an organization to focus on just regulatory requirements. Additionally or alternatively, the ROI may allow the user take a broader view of portions of a regulatory document by presenting the user with the categories and a classification of all obligations, all non-obligations, or both. The ROI output may be presented at once to the user in a simple, easy to view format.

### Exemplary System for Implementing the Regulatory Obligation Identifier

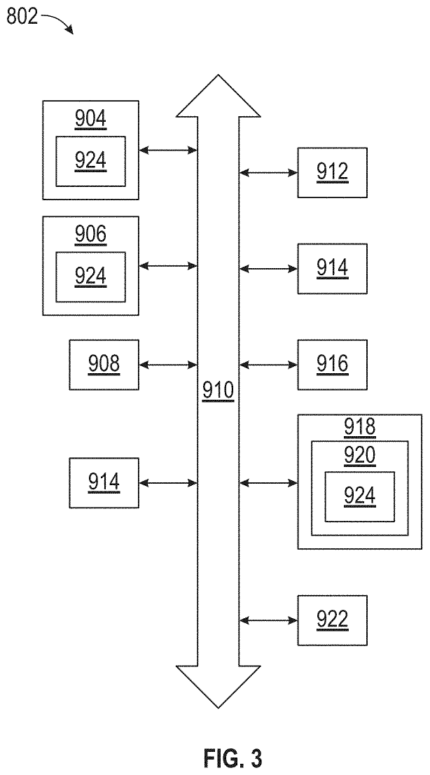

The regulatory obligation identifier discussed above may be implemented by a system. FIG. 3 illustrates a block diagram of an exemplary system 802, according to embodiments of the disclosure. The system may be a machine such as a computer, within which a set of instructions, causes the machine to perform any one of the steps and operations discussed herein, according to embodiments of the disclosure. In some embodiments, the machine can operate as a standalone device or may be connected (e.g., networked) to other machines. In a networked configuration, the machine may operate in the capacity of a server or a client machine in a server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, a switch or bridge, or any machine capable of executing a set of instructions (sequential or otherwise) that specify actions to be taken by that machine. A mobile device such as a PDA or a cellular phone may also include an antenna, a chip for sending and receiving radio frequency transmissions and communicating over cellular phone WAP and SMS networks, and a built-in keyboard. Further, while only a single machine is illustrated, the term “machine” shall also be taken to include any collection of machines that individually or jointly execute a set (or multiple sets) of instructions to perform any one of the methodologies discussed herein.

The exemplary computer 802 includes a processor 904 (e.g., a central processing unit (CPU), a graphics processing unit (GPU), or both), a main memory 906 (e.g., read-only memory (ROM), flash memory, dynamic random access memory (DRAM) such as synchronous DRAM (SDRAM) or Rambus DRAM (RDRAM), etc.), and a static memory 908 (e.g., flash memory, static random access memory (SRAM), etc.), which can communicate with each other via a bus 910.

The computer 902 may further include a video display 912 (e.g., a liquid crystal display (LCD) or a cathode ray tube (CRT)). The computer 902 also includes an alpha-numeric input device 914 (e.g., a keyboard), a cursor control device 916 (e.g., a mouse), a disk drive unit 918, a signal generation device 920 (e.g., a speaker), and a network interface device 922.

The drive unit 918 includes a machine-readable medium 920 on which is stored one or more sets of instructions 924 (e.g., software) embodying any one or more of the methodologies or functions described herein. The software may also reside, completely or at least partially, within the main memory 906 and/or within the processor 904 during execution thereof by the computer 902, the main memory 906 and the processor 904 also constituting machine-readable media. The software may further be transmitted or received over a network 804 via the network interface device 922.

While the machine-readable medium 920 is shown in an exemplary embodiment to be a single medium, the term “non-transitory computer-readable medium” should be taken to include a single medium or multiple media (e.g., a centralized or distributed database and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method for determining one or more predictions for meeting one or more regulatory requirements, the method comprising:
receiving regulatory text of one or more regulatory documents;
receiving information about an organization; and
using a machine-learning model to:
apply the regulatory text against the information about the organization; and
generate the one or more predictions, wherein the one or more predictions include one or more categories and a classification,
wherein the one or more categories include regulator action, exception/exemption, definition, background, example, regulatory requirement, conditionally permitted, calculations, and prohibition,
wherein the classification is an indicator of whether the organization is obligated to comply with the one or more regulatory requirements.

2. The method of claim 1, further comprising:
outputting the one or predictions, wherein the output comprises a probability for each of the one or more categories.

3. The method of claim 1, further comprising:
outputting one of the one or more categories having a highest probability.

4. The method of claim 1, wherein the classification is a binary indicator.

5. The method of claim 1, further comprising:
training the machine-learning model using a training dataset;
testing the trained machine-learning model using a test dataset;
determining whether the trained machine-learning model meets a target performance; and
when the trained machine-learning model does not meet the target performance:
changing the training dataset; and
repeating the training and testing using the changed training dataset.

6. The method of claim 5, wherein the training the machine-learning model comprises:
determining one or more relationships between annotations and data in an annotated dataset.

7. The method of claim 6, wherein the one or more relationships are determined by associating words in segments of the regulatory text to the annotations.

8. The method of claim 5, wherein the annotations include a citation identifier, a website link, a regulator, a data source, a name of one of the one or more regulatory documents, a topic, a corresponding category, a corresponding classification, or machine-learning information.

9. The method of claim 5, wherein the test dataset comprises text from multiple regulations and multiple topics.

10. The method of claim 5, wherein the changing the training dataset includes adding additional data to the training dataset.

11. The method of claim 10, wherein the additional data includes data belonging to the same category as data in the training dataset from an incorrect prediction.

12. The method of claim 5, wherein the changing the training dataset includes modifying existing data of the training dataset.

13. The method of claim 12, wherein the modifying the existing data includes modifying data in the training dataset from an incorrect prediction.

14. The method of claim 5, wherein the training the machine-learning model comprises:
generating pre-trained embeddings;
batching a training dataset into a configurable batch set, wherein the training dataset is included in the training dataset;
using integer identifiers to look up word embeddings on input text of the training dataset;
forming a convolution neural network; and
performing iterative optimizations.

15. The method of claim 14, wherein the generating the pre-trained embeddings comprises:
tokenizing the input text;
designating the words as vocabulary words;
generating a vector using the vocabulary words; and
providing the vector to the convolution neural network.

16. The method of claim 15, wherein the vocabulary words are regulation-based words.

17. The method of claim 5, wherein the training dataset includes a validation dataset, wherein the training the machine-learning model comprises:
tuning parameters using the training dataset;
tuning hyper parameters using the validation dataset; and
terminating the training of the machine-learning model based on one or more metrics.

18. The method of claim 5, further comprising:
developing the machine-learning model using different configurations;
comparing performances of the different configurations to determine a configuration with a highest performance,
wherein the training of the machine-learning model includes using the configuration with the highest performance.

19. The method of claim 1, wherein the generating the one or more predictions includes determining one or more probabilities using a softmax layer of a convolution neural network used by the machine-learning model.

20. A non-transitory computer readable medium, the computer readable medium including instructions that, when executed, perform a method for determining one or more predictions for meeting one or more regulatory requirements, the method comprising:
receiving regulatory text of one or more regulatory documents;
receiving information about an organization; and
using a machine-learning model to:
apply the regulatory text against the information about the organization; and
generate the one or more predictions, wherein the one or more predictions include one or more categories and a classification,
wherein the one or more categories include regulator action, exception/exemption, definition, background, example, regulatory requirement, conditionally permitted, calculations, and prohibition,
wherein the classification is an indicator of whether the organization is obligated to comply with the one or more regulatory requirements.
